(19) United States
(12) Patent Application Publication
(10) Pub. No.: US 2021/0287708 A1
(43) Pub. Date: Sep. 16, 2021

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventors: Eiki OZAWA, Minami-ashigara-shi (JP); Norihito KASADA, Minami-ashigara-shi (JP); Takashi FUJIMOTO, Minami-ashigara-shi (JP)

(73) Assignee: FUJIFILM Corporation, Tokyo (JP)

(21) Appl. No.: 17/196,349

(22) Filed: Mar. 9, 2021

(30) Foreign Application Priority Data
Mar. 13, 2020 (JP) 2020-043912

(51) Int. Cl. G11B 5/706; G11B 5/735; G11B 5/008; G11B 5/714

(52) U.S. Cl. CPC G11B 5/70642; G11B 5/714; G11B 5/00817; G11B 5/7356

(57) ABSTRACT

The magnetic recording medium includes a non-magnetic support, and a magnetic layer containing a ferromagnetic powder in which the ferromagnetic powder is an ε-iron oxide powder, and a vertical squareness ratio of the magnetic recording medium measured after pressing the magnetic layer at a pressure of 70 atm is 0.50 to 0.95.

### CROSS-REFERENCE TO RELATED APPLICATIONS

This application claims priority under 35 U.S.C 119 to Japanese Patent Application No. 2020-043912 filed on Mar. 13, 2020. The above application is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

Magnetic recording media have been widely used as recording media for data storage for recording and storing various pieces of data (see, for example, JP2020-009526A).

### SUMMARY OF THE INVENTION

In a magnetic recording medium, a magnetic layer containing a ferromagnetic powder is usually provided on a non-magnetic support. Regarding the ferromagnetic powder contained in the magnetic layer of the magnetic recording medium, for example, claim 1 of JP2020-009526A discloses that a magnetic layer contains a magnetic powder consisting of magnetic particles containing ε-phase iron oxide. In recent years, an ε-iron oxide powder has been attracting attention as a ferromagnetic powder for magnetic recording.

Data recorded on various recording media such as a magnetic recording medium is called hot data, warm data, and cold data depending on access frequencies (reproducing frequencies). The access frequencies decrease in the order of hot data, warm data, and cold data, and the recording and storing of the data with low access frequency (for example, cold data) for a long period of time is referred to as “archive”. The data amount recorded and stored on a recording medium for the archive increases in accordance with a dramatic increase in information contents and digitization of various information in recent years, and accordingly, a recording and reproducing system suitable for the archive is gaining attention.

A magnetic recording medium with less deterioration in electromagnetic conversion characteristics during reproducing data after long-term storage described above, compared to the state before the long-term storage is suitable as a recording medium for archiving. However, according to the research of the inventors, it is clear that, in the magnetic recording medium containing an ε-iron oxide powder as the ferromagnetic powder in the magnetic layer, electromagnetic conversion characteristics tend to easily deteriorate after the long-term storage described above.

One aspect of the invention is to provide a magnetic recording medium containing ε-iron oxide powder as a ferromagnetic powder and in which deterioration of electromagnetic conversion characteristics after long-term storage is suppressed.

According to one aspect of the invention, there is provided a magnetic recording medium comprising:

a non-magnetic support, and a magnetic layer containing a ferromagnetic powder,

in which the ferromagnetic powder is an ε-iron oxide powder, and

a vertical squareness ratio of the magnetic recording medium measured after pressing the magnetic layer at a pressure of 70 atm is 0.50 to 0.95

Hereinafter, the vertical squareness ratio of the magnetic recording medium measured after pressing the magnetic layer with a pressure of 70 atm is also referred to as “SQ after pressing”. “SQ” is an abbreviation for the squareness ratio. In addition, regarding the unit, 1 atm =101,325 Pa (Pascal)=101,325 N (Newton)/m².

In one embodiment, the magnetic layer may contain inorganic oxide-based particles.

In one embodiment, the inorganic oxide-based particles may be composite particles of an inorganic oxide and a polymer.

In one embodiment, the SQ after pressing may be 0.50 to 0.80.

In one embodiment, the ε-iron oxide powder may contain one or more kinds of elements selected from the group consisting of a gallium element, a cobalt element, and a titanium element.

In one embodiment, the magnetic recording medium may further include a non-magnetic layer containing a non-magnetic powder between the non-magnetic support and the magnetic layer.

In one embodiment, the magnetic recording medium may include a back coating layer containing a non-magnetic powder on a surface side of the non-magnetic support opposite to the surface side provided with the magnetic layer.

In one embodiment, the magnetic recording medium may be a magnetic tape.

According to another aspect of the invention, there is provided a magnetic tape cartridge including the magnetic tape described above.

According to still another aspect of the invention, there is provided a magnetic recording and reproducing device including the magnetic recording medium described above.

According to one aspect of the invention, it is possible to provide a magnetic recording medium containing ε-iron oxide powder as a ferromagnetic powder and in which deterioration of electromagnetic conversion characteristics after long-term storage is suppressed. In addition, according to one aspect of the invention, it is possible to provide a magnetic tape cartridge and a magnetic recording and reproducing device including the magnetic recording medium.

### DESCRIPTION OF THE PREFERRED EMBODIMENTS

### Magnetic Recording Medium

An embodiment of the invention relates to a magnetic recording medium including a non-magnetic support, and a magnetic layer including a ferromagnetic powder. The ferromagnetic powder is an ε-iron oxide powder, and a vertical squareness ratio of a magnetic recording medium measured after pressing the magnetic layer at a pressure of 70 atm is 0.50 to 0.95.

The pressure of 70 atm for pressing the magnetic layer is a surface pressure applied to a surface of the magnetic layer by pressing. In the invention and the specification, the “surface of the magnetic layer” is identical to the surface of the magnetic recording medium on the magnetic layer side. By causing the magnetic recording medium to pass between two rolls while causing the magnetic recording medium to run at a speed of 20 m/min, the surface pressure of 70 atm is applied to the surface of the magnetic layer. A tension of 0.5 N/m is applied to the running magnetic recording medium in a running direction. For example, for a tape-shaped magnetic recording medium (that is, a magnetic tape), a tension of 0.5 N/m is applied in the longitudinal direction of the running magnetic tape. The pressing is performed by causing the magnetic recording medium to pass between two rolls six times in total and applying the surface pressure of 70 atm at each time when passing each roll. A metal roll is used as the roll, and the roll is not heated. An environment for performing the pressing is an environment in which an ambient temperature is 20° C. to 25° C. and relative humidity is 40% to 60%. The magnetic recording medium to which the pressing is performed, is a magnetic recording medium which is not subjected to the long-term storage for 10 years or longer in a room temperature environment of relative humidity of 40% to 60%, and the storage corresponding to such long-term storage or an acceleration test corresponding to such long-term storage. The same applies to various physical properties relating to the magnetic recording medium described in the invention and the specification, unless otherwise noted.

The pressing described above can be performed by using a calender treatment device used for manufacturing a magnetic recording medium. For example, a magnetic tape accommodated in a magnetic tape cartridge is taken out and caused to pass through calender rolls in the calender treatment device, and accordingly, the magnetic tape can be pressed at a pressure of 70 atm.

In the invention and the specification, the “vertical squareness ratio” is squareness ratio measured in the vertical direction of the magnetic recording medium. The “vertical direction” described with respect to the squareness ratio is a direction orthogonal to the surface of the magnetic layer, and can also be referred to as a thickness direction. In the invention and the specification, the vertical squareness ratio is obtained by the following method.

A sample piece having a size that can be introduced into a vibrating sample magnetometer is cut out from the magnetic recording medium to be measured. Regarding the sample piece, using the vibrating sample magnetometer, a magnetic field is applied to a vertical direction of a sample piece (direction orthogonal to the surface of the magnetic layer) with a maximum applied magnetic field of 3979 kA/m, a measurement temperature of 296 K, and a magnetic field sweep speed of 8.3 kA/m/sec, and a magnetization strength of the sample piece with respect to the applied magnetic field is measured. The measured value of the magnetization strength is obtained as a value after diamagnetic field correction and a value obtained by subtracting magnetization of a sample probe of the vibrating sample magnetometer as background noise. In a case where the magnetization strength at the maximum applied magnetic field is Ms and the magnetization strength at zero applied magnetic field is Mr, the squareness ratio SQ is a value calculated as SQ=Mr/Ms. The measurement temperature is referred to as a temperature of the sample piece, and by setting the ambient temperature around the sample piece to a measurement temperature, the temperature of the sample piece can be set to the measurement temperature by realizing temperature equilibrium.

The measurement described above for obtaining the SQ after pressing is performed within 24 hours after pressing by the method described above.

The inventors of the invention have conducted intensive studies regarding the magnetic recording medium including the magnetic layer containing an ε-iron oxide powder to prevent a deterioration in electromagnetic conversion characteristics after long-term storage, and found that it is suitable to press the magnetic layer at a pressure of 70 atm in an acceleration test corresponding to an example of archiving. This point will be further described below.

For example, the magnetic tape is generally accommodated in a magnetic tape cartridge in a state of being wound around a reel. Accordingly, the long-term storage of the magnetic tape after the data with a low access frequency is recorded, is also performed in a state of being accommodated in the magnetic tape cartridge. In the magnetic tape wound around a reel, a surface of a magnetic layer and a surface of a back coating layer (in a case of including a back coating layer) or a surface of the non-magnetic support on a side opposite to a surface of the magnetic layer (in a case of not including a back coating layer) come into contact with each other, and accordingly, the magnetic layer is pressed in the magnetic tape cartridge. Therefore, during long-term storage, the ferromagnetic powder contained in the magnetic layer can also be pressed. In this regard, the inventors have considered that, in a case where the ε-iron oxide powder receives a pressure by pressing, magnetic properties tends to easily deteriorate. The inventors have surmised that, in the magnetic recording medium including the magnetic layer containing the ε-iron oxide powder, the deterioration in magnetic properties of the ε-iron oxide powder that has received a pressure during long-term storage is a reason for that the electromagnetic conversion characteristics tends to easily deteriorate after the long-term storage described above. Meanwhile, in recent years, in order to increase the capacity of the magnetic tape cartridge, it is desired to increase a total length of the magnetic tape accommodated in the magnetic tape cartridge. However, it is considered that, as the total length of the magnetic tape accommodated in the magnetic tape cartridge increases, the pressure applied to the magnetic layer in the magnetic tape cartridge tends to increase. In addition, at a position closer to a reel, a greater pressure is received and the electromagnetic conversion characteristics tends to more easily deteriorate. Accordingly, in order to further increase the capacity, it is desired to improve the electromagnetic conversion characteristics of the magnetic recording medium including the magnetic layer containing the ε-iron oxide powder after long-term storage as described above.

As a result of various simulation performed by the inventors, it is determined that it is suitable to press the magnetic layer at a pressure of 70 atm in the acceleration test corresponding to long-term storage (example of archive) for approximately 10 years in an environment of the room temperature and relative humidity of 40% to 60%. In the invention and the present specification, the room temperature means a temperature in the range of 20° C. to 25° C. Therefore, the inventors have evaluated the electromagnetic conversion characteristics after pressing the magnetic layer at 70 atm, and as a result of intensive studies based on the results of this evaluation, the inventors have determined that the magnetic recording medium having the SQ after pressing in the range described above has less deterioration in electromagnetic conversion characteristics after pressing the magnetic layer at 70 atm, that is, after placing the magnetic layer in a state corresponding to the long-term storage, while the magnetic layer contains the ε-iron oxide powder. The fact that the vertical squareness ratio after pressing has to be controlled is a new finding that has not been known in the related art and is not disclosed in JP2020-009526A described above.

Hereinafter, the magnetic recording medium will be further described in detail.

### SQ After Pressing

In the magnetic recording medium described above, the SQ after pressing is 0.50 or more, preferably 0.53 or more, more preferably 0.55 or more, and even more preferably 0.57 or more for the reason described above. The SQ after pressing is 0.95 or less, preferably 0.93 or less, more preferably 0.90 or less, even more preferably 0.87 or less, still preferably 0.85 or less, and still more preferably 0.83 or less, and still even more preferably 0.80 or less, and further preferably 0.78 or less, and further more preferably 0.75 or less, for the reasons described above.

The SQ after pressing can be controlled by, for example, producing conditions of the ε-iron oxide powder used for forming the magnetic layer, a kind of non-magnetic powder used for forming the magnetic layer, and the like. The details thereof will be described later.

### Magnetic Layer

### 249 -Iron Oxide Powder

The magnetic recording medium contains an ε-iron oxide powder as a ferromagnetic powder in the magnetic layer. In the invention and the specification, the “ε-iron oxide powder” is a ferromagnetic powder in which an ε-iron oxide type crystal structure (ε phase) is detected as a main phase by X-ray diffraction analysis. For example, in a case where the diffraction peak at the highest intensity in the X-ray diffraction spectrum obtained by the X-ray diffraction analysis belongs to an ε-iron oxide type crystal structure (ε phase), it is determined that the ε-iron oxide type crystal structure is detected as a main phase. In addition to the ε phase of the main phase, an a phase and/or a γ phase may or may not be contained. The ε-iron oxide powder in the invention and the specification includes a so-called unsubstituted type ε-iron oxide powder composed of iron and oxygen, and a so-called substituted type ε-iron oxide powder containing one or more kinds of substitutional elements to be substituted with iron.

### Method for Producing ε-Iron Oxide Powder

As a producing method of the ε-iron oxide powder, a producing method from a goethite, and a reverse micelle method are known. All of the producing methods is well known. In addition, for a method of producing the ε-iron oxide powder in which a part of iron is substituted with a substitutional element, a description disclosed in J. Jpn. Soc. Powder Metallurgy Vol. 61 Supplement, No. S1, pp. S280-5284, J. Mater. Chem. C, 2013, 1, pp. 5200-5206 can be referred to, for example.

As an example, for example, the ε-iron oxide powder contained in the magnetic layer of the magnetic recording medium can be obtained by a producing method for obtaining an ε-iron oxide powder through,

preparing a precursor of an ε-iron oxide (hereinafter, also referred to as a “precursor preparation step”),

subjecting the precursor into a coating film forming process (hereinafter, also referred to as a “coating film forming step”),

heating the precursor after the coating film forming process to convert the precursor into an ε-iron oxide (hereinafter, also referred to as a “heat treatment step”), and performing a coating film removing process of the ε-iron oxide (hereinafter, also referred to as a “coating film removing step”).

Hereinafter, the producing method will be further described below. However, the producing method described below is an example, and the ε-iron oxide powder described above is not limited to an ε-iron oxide powder produced by the producing method exemplified below.

### Precursor Preparation Step

The precursor of the ε-iron oxide refers to a substance that contains an ε-iron oxide type crystal structure as a main phase by heating. The precursor can be, for example, iron, a hydroxide containing an element capable of substituting a part of iron in a crystal structure, an oxyhydroxide (oxide hydroxide), or the like. The precursor preparation step can be carried out by using a coprecipitation method, a reverse micelle method, or the like. Such a method for preparing such a precursor is well known, and the precursor preparation step in the producing method described above can be performed by a well-known method. For example, regarding the method for preparing the precursor, well-known technologies in paragraphs 0017 to 0021 and examples of JP2008-174405A, paragraphs 0025 to 0046 and examples of WO2016/047559A1, paragraphs 0038 to 0040, 0042, 0044, and 0045 and examples of WO2008/149785A1 can be referred to.

An ε-iron oxide, which does not contain a substitutional element to be substituted with a part of iron (Fe), can be represented by a compositional formula: Fe₂O₃. On the other hand, an ε-iron oxide in which a part of iron is substituted with, for example, 1 to 3 elements can be represented by a compositional formula: A¹ₓA²_{y}A³_{z}Fe_{(2-x-y-z)}O₃. A¹, A²,and A³ each independently represent a substitutional element to be substituted with iron, and x, y and z are each independently 0 or more and less than 2, but at least one of them is more than 0, and x+y+z is less than 2. The ε-iron oxide powder may or may not contain a substitutional element to be substituted with iron, and preferably contains. The magnetic properties of ε-iron oxide powder can be adjusted by the kind and amount of substitutional elements. For example, the SQ of the magnetic recording medium after pressing can be controlled to be in the range described above, by adjusting the magnetic properties of the ε-iron oxide powder as described above, performing classification as will be described later, and/or a kind of a non-magnetic powder used as a projection formation agent as will be described later. In a case where a substitutional element is included, examples of the substitutional element include one or more of Ga, Al, In, Rh, Mn, Co, Ni, Zn, Ti, and Sn. For example, in the compositional formula described above, A¹ can be one or more kinds selected from the group consisting of Ga, Al, In, and Rh, A² can be one or more kinds selected from the group consisting of Mn, Co, Ni, and Zn, and A³ can be one or more kinds selected from the group consisting of Ti and Sn. As the substitutional element, one or more kinds selected from the group consisting of Ga, Co, and Ti are preferable. In a case of producing an ε-iron oxide powder containing a substitutional element to be substituted with iron, a part of a compound that is a source of iron in the ε-iron oxide may be replaced with a compound of the substitutional element. The composition of the ε-iron oxide powder to be obtained can be controlled by the amount of substitution. Examples of the compound that is a source of iron and various substitutional elements include inorganic salts such as nitrates, sulfates, and chlorides (may be hydrates), organic salts such as pentakis (hydrogen oxalate) salts (may be a hydrate), hydroxide, and oxyhydroxide.

### Coating Film Forming Step

In a case where the precursor is heated after the coating film forming process, a reaction of converting the precursor into an ε-iron oxide can proceed under the coating film. It is also considered that the coating film can play a role in preventing sintering from occurring during heating. From a viewpoint of ease of coating film formation, the coating film forming process is preferably performed in a solution, and more preferably performed by adding a coating film forming agent (compound for coating film forming) to the solution containing the precursor. For example, in a case where the coating film forming process is performed in the same solution following the precursor preparation, a coating film forming agent can be added to the solution after the precursor preparation and stirred to form a coating film on the precursor. A silicon-containing coating film can be used as a coating film preferable in a viewpoint that a coating film can be easily formed on the precursor in the solution. As the coating film forming agent for forming the silicon-containing coating film, a silane compound such as alkoxysilane can be used. By hydrolysis of the silane compound, a silicon-containing coating film can be formed on the precursor, preferably by using a sol-gel method. Specific examples of the silane compound include tetraethoxysilane (tetraethyl orthosilicate (TEOS), tetramethoxysilane, and various silane coupling agents. Regarding the coating film forming process, well-known technologies in paragraphs 0022 and examples of JP2008-174405A, paragraphs 0047 to 0049 and examples of WO2016/047559A1, and paragraphs 0041 and 0043 and examples of WO2008/149785A1 can be referred to. For example, the coating film forming process can be carried out by stirring a solution containing the precursor and the coating film forming agent at a liquid temperature of 50° C. to 90° C. for approximately 5 to 36 hours. The coating film may cover the entire surface of the precursor, or a part of the surface of the precursor may not be covered by the coating film.

### Heat Treatment Step

The precursor after the coating film forming process is heated to convert the precursor into an ε-iron oxide. The heat treatment can be performed on, for example, a powder collected from the solution subjected to the coating film forming process (powder of the precursor having the coating film). Regarding the heat treatment step, well-known technologies in paragraph 0023 and examples of JP2008-174405A, paragraph 0050 and examples of WO2016/047559A1, and paragraphs 0041 and 0043 and examples of WO2008/149785A1 can be referred to. The heat treatment step can be performed, for example, in a heat treatment furnace having a furnace inner temperature of 900° C. to 1,200° C. for approximately 3 to 6 hours. As the temperature of the heat treatment step increases and/or as the heat treatment time increases, an average particle size of the ε-iron oxide powder to be obtained tends to increase.

### Coating Film Removing Step

The heat treatment step can be performed to convert the precursor having a coating film into ε-iron oxide. Since the coating film remains on the ε-iron oxide thus obtained, the coating film removing process is preferably performed. Regarding the coating film removing process, well-known technologies in paragraph 0025 and examples of JP2008-174405A, and paragraph 0053 and examples of WO2008/149785A1 can be referred to. The coating film removing process can be performed, for example, by stirring the ε-iron oxide having the coating film in an aqueous sodium hydroxide solution having a concentration of approximately 1 to 5 mol/L and a liquid temperature of approximately 60° C. to 90° C. for approximately 5 to 36 hours. However, the ε-iron oxide powder contained in the magnetic layer of the magnetic recording medium may be produced without undergoing the coating film removing process, and the coating film may not be completely removed in the coating film removing process and a part of the coating film may remain.

Well-known steps can also be optionally performed before and/or after the various steps described above. Examples of such steps include various well-known steps such as classification, filtration, washing, and drying. The inventors have considered that a decrease in amount of particles having a comparatively larger particle size (hereinafter, “coarse particle component”), among the particles of the ε-iron oxide powder contained in the magnetic layer, contributes to an increase of the value of the vertical squareness ratio of the magnetic recording medium. In addition, the inventors have surmised that the particles having a comparatively small particle size (hereinafter, “fine particle component”) are easily pushed into the magnetic layer by receiving a pressure, and the pushing may contribute to a deterioration in magnetic properties or hardly exhibiting sufficient magnetic properties. This is considered as one of reasons why the value of the vertical squareness ratio of the magnetic recording medium decreases after pressing. From the above viewpoints, a decrease in amount of the coarse particle component and/or the fine particle component in the ε-iron oxide powder contained in the magnetic layer can be one of methods for controlling the value of SQ after pressing. For example, the classification can be performed by a well-known classification process such as centrifugal separation, decantation, or magnetic separation. For example, after the centrifugal separation, among particles of various particle sizes, particles having a larger particle size are likely to precipitate, and particles having a smaller particle size are likely to be dispersed in a supernatant liquid. Accordingly, for example, in a case where it is desired to remove particles having a smaller particle size, it is preferable to collect the precipitate after centrifugal separation. On the other hand, for example, in a case where it is desired to remove particles having a greater particle size, it is preferable to collect the supernatant liquid after centrifugal separation. Examples of the classification conditions include the number of times of classification processes, a process time, a centrifugal force applied in the centrifugal separation, a generated magnetic field strength in the magnetic separation, a frequency of an AC magnetic field, in a case of using the AC magnetic field, and the like. The formation of a magnetic layer by using ε-iron oxide powder with a reduced amount of coarse particle components and/or fine particle components by adjusting one or more of these classification conditions is preferable, in a viewpoint of controlling the SQ after pressing.

### Average Particle Size

The average particle size of the ε-iron oxide powder contained in the magnetic layer of the magnetic recording medium is preferably 5.0 nm or more, more preferably 6.0 nm or more, even more preferably 7.0 nm or more, still preferably 8.0 nm or more, and still more preferably 9.0 nm or more, from a viewpoint of magnetization stability. From a viewpoint of high-density recording, the average particle size of the ε-iron oxide powder is preferably 20.0 nm or less, more preferably 19.0 nm or less, even more preferably 18.0 nm or less, still preferably 17.0 nm or less, still more preferably 16.0 nm or less, and still even more preferably 15.0 nm or less.

In the invention and the specification, average particle sizes of various powder such as the ε-iron oxide powder and the like are values measured by the following method with a transmission electron microscope, unless otherwise noted.

The powder is imaged at an imaging magnification ratio of 100,000 with a transmission electron microscope, the image is printed on photographic printing paper or displayed on a display so that the total magnification ratio of 500,000 to obtain an image of particles configuring the powder. A target particle is selected from the obtained image of particles, an outline of the particle is traced with a digitizer, and a size of the particle (primary particle) is measured. The primary particle is an independent particle which is not aggregated.

The measurement described above is performed regarding 500 particles randomly extracted. An arithmetic mean of the particle size of 500 particles obtained as described above is an average particle size of the powder. In addition, the content of particles of various particle sizes of the ε-iron oxide powder is obtained by using the 500 particles obtained here.

As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. The average particle size shown in examples which will be described later is a value measured by using transmission electron microscope H-9000 manufactured by Hitachi, Ltd. as the transmission electron microscope, and image analysis software KS-400 manufactured by Carl Zeiss as the image analysis software, unless otherwise noted. In the invention and the specification, the powder means an aggregate of a plurality of particles. For example, the ferromagnetic powder means an aggregate of a plurality of ferromagnetic particles. The aggregate of a plurality of particles is not limited to an embodiment in which particles configuring the aggregate directly come into contact with each other, but also includes an embodiment in which a binding agent, an additive, or the like which will be described later is interposed between the particles. A term, particles may be used for representing the powder.

As a method of collecting a sample powder from the magnetic recording medium in order to measure the particle size, a method disclosed in a paragraph 0015 of JP2011-048878A can be used, for example.

In the invention and the specification, unless otherwise noted,

(1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length,

(2) in a case where the shape of the particle is a planar shape or a columnar shape (here, a thickness or a height is smaller than a maximum long diameter of a plate surface or a bottom surface), the particle size is shown as a maximum long diameter of the plate surface or the bottom surface, and

(3) in a case where the shape of the particle is a sphere shape, a polyhedron shape, or an unspecified shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic mean of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably 50% to 90% by mass and more preferably 60% to 90% by mass. A high filling percentage of the ferromagnetic powder in the magnetic layer is preferable from a viewpoint of improvement of recording density.

### Binding Agent

The magnetic recording medium can be a coating type magnetic recording medium, and can include a binding agent in the magnetic layer. The binding agent is one or more kinds of resin. As the binding agent, various resins generally used as the binding agent of the coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, or a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. The resin may be a homopolymer or a copolymer. These resins can be used as the binding agent even in the non-magnetic layer and/or a back coating layer which will be described later.

For the binding agent described above, description disclosed in paragraphs 0028 to 0031 of JP2010-024113A can be referred to. In addition, the binding agent may be a radiation curable resin such as an electron beam curable resin. For the radiation curable resin, paragraphs 0044 and 0045 of JP2011-048878A can be referred to. An average molecular weight of the resin used as the binding agent can be, for example, 10,000 to 200,000 as a weight-average molecular weight. The weight-average molecular weight of the invention and the specification is a value obtained by performing polystyrene conversion of a value measured by gel permeation chromatography (GPC) under the following measurement conditions. The weight-average molecular weight of the binding agent shown in examples which will be described later is a value obtained by performing polystyrene conversion of a value measured under the following measurement conditions. The amount of the binding agent used can be, for example, 1.0 to 30.0 parts by mass with respect to 100.0 parts by mass of the ferromagnetic powder.

### GPC Device: HLC-8120 (Manufactured by Tosoh Corporation)

Column: TSK gel Multipore HXL-M (manufactured by Tosoh Corporation, 7.8 mmID (inner diameter)' 30.0 cm)

### Eluent: Tetrahydrofuran (THF)

In addition, a curing agent can also be used together with the resin which can be used as the binding agent. As the curing agent, in one embodiment, a thermosetting compound which is a compound in which a curing reaction (crosslinking reaction) proceeds due to heating can be used, and in another embodiment, a photocurable compound in which a curing reaction (crosslinking reaction) proceeds due to light irradiation can be used. At least a part of the curing agent is included in the magnetic layer in a state of being reacted (crosslinked) with other components such as the binding agent, by proceeding the curing reaction in the magnetic layer forming step. This point is the same as regarding a layer formed by using a composition, in a case where the composition used for forming the other layer includes the curing agent. The preferred curing agent is a thermosetting compound, polyisocyanate is suitable. For details of the polyisocyanate, descriptions disclosed in paragraphs 0124 and 0125 of JP2011-216149A can be referred to. The amount of the curing agent can be, for example, 0 to 80.0 parts by mass with respect to 100.0 parts by mass of the binding agent in the magnetic layer forming composition, and is preferably 50.0 to 80.0 parts by mass, from a viewpoint of improvement of hardness of the magnetic layer.

The description regarding the binding agent and the curing agent described above can also be applied to the non-magnetic layer and/or the back coating layer. In this case, the description regarding the content can be applied by replacing the ferromagnetic powder with the non-magnetic powder.

### Additives

The magnetic layer may include one or more kinds of additives, as necessary, together with the various components described above. As the additives, a commercially available product can be suitably selected and used according to the desired properties. Alternatively, a compound synthesized by a well-known method can be used as the additives. As the additives, the curing agent described above is used as an example. In addition, examples of the additive included in the magnetic layer include a non-magnetic powder, a lubricant, a dispersing agent, a dispersing assistant, a fungicide, an antistatic agent, an antioxidant, and carbon black. As the additives, a commercially available product can be suitably selected and used according to the desired properties. In addition, for example, for the lubricant, a description disclosed in paragraphs 0030 to 0033, 0035, and 0036 of JP2016-126817A can be referred to. The non-magnetic layer may include the lubricant. For the lubricant which may be included in the non-magnetic layer, a description disclosed in paragraphs 0030, 0031, 0034, 0035, and 0036 of JP2016-126817A can be referred to. For the dispersing agent, a description disclosed in paragraphs 0061 and 0071 of JP2012-133837A can be referred to. The dispersing agent may be included in the non-magnetic layer. For the dispersing agent which may be included in the non-magnetic layer, a description disclosed in a paragraph 0061 of JP2012-133837A can be referred to.

### Projection Formation Agent

The magnetic layer preferably contains one kind or two or more kinds of non-magnetic powders. As the non-magnetic powder, a non-magnetic powder (hereinafter, referred to as “projection formation agent”) which can function as a projection formation agent that forms projections that appropriately project on the surface of the magnetic layer can be used. As the projection formation agent, particles of an inorganic substance can be used, particles of an organic substance can be used, and composite particles of the inorganic substance and the organic substance can also be used. Examples of the inorganic substance include inorganic oxide such as metal oxide, metal carbonate, metal sulfate, metal nitride, metal carbide, and metal sulfide, and inorganic oxide is preferable. In one embodiment, the projection formation agent can be inorganic oxide-based particles. Here, “-based” means “-containing”. One embodiment of the inorganic oxide-based particles is particles consisting of inorganic oxide. Another embodiment of the inorganic oxide-based particles is composite particles of inorganic oxide and an organic substance, and as a specific example, composite particles of inorganic oxide and a polymer can be used. As such particles, for example, particles obtained by binding a polymer to a surface of the inorganic oxide particle can be used.

An average particle size of the projection formation agent is, for example, 30 to 300 nm and is preferably 40 to 200 nm. As the shape of the particles is a shape close to a sphere, indentation resistance exerted during a pressure is applied is small, and accordingly, the particles are easily pushed into the magnetic layer. With respect to this, in a case where the shape of the particles is a shape other than the sphere, for example, a shape of a so-called deformed shape, a large indentation resistance is easily exerted, in a case where a pressure is applied, and accordingly, particles are hardly pushed into the magnetic layer. In addition, regarding the particles having a low surface smoothness in which a surface of the particle is not even, the large indentation resistance is easily exerted, in a case where a pressure is applied, and accordingly, the particles are hardly pushed into the magnetic layer. It is surmised that, in a case where the projection formation agent is hardly pushed into the magnetic layer, even in a case where it is pressed, a role of decreasing the pressure applied to the particles of the ε-iron oxide powder, in a case where the magnetic layer is pressed, can be played by the projection formation agent, and as a result, the magnetic properties of the ε-iron oxide powder can be decreased. That is, it is surmised that the use of a projection formation agent that is difficult to be pushed into the magnetic layer even in a case where pressure is applied contributes to controlling the SQ after pressing to be in the range described above.

### Abrasive

As the non-magnetic powder included in the magnetic layer, a non-magnetic powder that can function as an abrasive (hereinafter, referred to as an “abrasive”) can also be used. The abrasive is preferably a non-magnetic powder having Mohs hardness exceeding 8 and more preferably a non-magnetic powder having Mohs hardness equal to or greater than 9. With respect to this, the Mohs hardness of the projection formation agent can be, for example, equal to or smaller than 8 or equal to or smaller than 7. A maximum value of Mohs hardness is 10 of diamond. Specific examples thereof include powders of alumina (for example, Al₂O₃), silicon carbide, boron carbide (for example, B₄C), SiO₂, TiC, chromium oxide (for example, Cr₂O₃), cerium oxide, zirconium oxide (for example, ZrO₂), non-magnetic iron oxide, diamond, and the like, and among these, alumina powder such as α-alumina and silicon carbide powder are preferable. An average particle size of the abrasive is, for example, in a range of 30 to 300 nm and preferably in a range of 50 to 200 nm.

From a viewpoint of causing the projection formation agent and the abrasive to exhibit these functions in more excellent manner, a content of the projection formation agent in the magnetic layer is preferably 1.0 to 4.0 parts by mass and more preferably 1.2 to 3.5 parts by mass, with respect to 100.0 parts by mass of the ferromagnetic powder. Meanwhile, a content of the abrasive in the magnetic layer is preferably 1.0 to 20.0 parts by mass, more preferably 3.0 to 15.0 parts by mass, and even more preferably 4.0 to 10.0 parts by mass, with respect to 100.0 parts by mass of the ferromagnetic powder.

As an example of the additive which can be used in the magnetic layer including the abrasive, a dispersing agent disclosed in paragraphs 0012 to 0022 of JP2013-131285A can be used as a dispersing agent for improving dispersibility of the abrasive in the magnetic layer forming composition. In addition, for the dispersing agent, a description disclosed in paragraphs 0061 and 0071 of JP2012-133837A can be referred to. The dispersing agent may be included in the non-magnetic layer. For the dispersing agent which may be included in the non-magnetic layer, a description disclosed in a paragraph 0061 of JP2012-133837A can be referred to.

The magnetic layer described above can be provided on the surface of the non-magnetic support directly or indirectly through the non-magnetic layer.

### Non-Magnetic Layer

The non-magnetic powder used in the non-magnetic layer may be powder of an inorganic substance or powder of an organic substance. In addition, carbon black and the like can be used. Examples of the inorganic substance include metal, metal oxide, metal carbonate, metal sulfate, metal nitride, metal carbide, and metal sulfide. These non-magnetic powder can be purchased as a commercially available product or can be manufactured by a well-known method. For details thereof, descriptions disclosed in paragraphs 0146 to 0150 of JP2011-216149A can be referred to. For carbon black capable of being used in the non-magnetic layer, a description disclosed in paragraphs 0040 and 0041 of JP2010-024113A can be referred to. The content (filling percentage) of the non-magnetic powder of the non-magnetic layer is preferably 50% to 90% by mass and more preferably 60% to 90% by mass.

The non-magnetic layer can include a binding agent and can also include additives. In regards to other details of a binding agent or additives of the non-magnetic layer, the well-known technology regarding the non-magnetic layer can be applied. In addition, in regards to the type and the content of the binding agent, and the type and the content of the additive, for example, the well-known technology regarding the magnetic layer can be applied.

The non-magnetic layer of the invention and the specification also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having coercivity equal to or smaller than 100 Oe, or a layer having a residual magnetic flux density equal to or smaller than 10 mT and coercivity equal to or smaller than 100 Oe. It is preferable that the non-magnetic layer does not have a residual magnetic flux density and coercivity.

### Non-Magnetic Support

Next, the non-magnetic support will be described. As the non-magnetic support (hereinafter, also simply referred to as a “support”), well-known components such as polyethylene terephthalate, polyethylene naphthalate, polyamide, polyamide imide, aromatic polyamide subjected to biaxial stretching are used. Among these, polyethylene terephthalate, polyethylene naphthalate, and polyamide are preferable. Corona discharge, plasma treatment, easy-bonding treatment, or heat treatment may be performed with respect to these supports in advance.

### Back Coating Layer

The magnetic recording medium may or may not include a back coating layer including a non-magnetic powder on a surface side of the non-magnetic support opposite to the surface side provided with the magnetic layer. The back coating layer preferably includes any one or both of carbon black and inorganic powder. The back coating layer can include a binding agent and can also include additives. In regards to the binding agent included in the back coating layer and various additives, a well-known technology regarding the back coating layer can be applied, and a well-known technology regarding the list of the magnetic layer and/or the non-magnetic layer can also be applied. For example, for the back coating layer, descriptions disclosed in paragraphs 0018 to 0020 of JP2006-331625A and page 4, line 65, to page 5, line 38, of U.S. Pat. No. 7,029,774B can be referred to.

### Various Thicknesses

A thickness of the non-magnetic support is preferably 3.0 to 6.0 μm.

A thickness of the magnetic layer is preferably equal to or smaller than 0.15 μm and more preferably equal to or smaller than 0.1 μm, from a viewpoint of realization of high-density recording required in recent years. The thickness of the magnetic layer is even more preferably 0.01 to 0.1 μm. The magnetic layer may be at least one layer, or the magnetic layer can be separated to two or more layers having different magnetic properties, and a configuration regarding a well-known multilayered magnetic layer can be applied. A thickness of the magnetic layer which is separated into two or more layers is a total thickness of the layers.

A thickness of the non-magnetic layer is, for example, 0.1 to 1.5 μm and preferably 0.1 to 1.0 μm.

A thickness of the back coating layer is preferably equal to or smaller than 0.9 μm and even more preferably 0.1 to 0.7 μm.

The thicknesses of various layers and the non-magnetic support of the magnetic recording medium can be obtained by a well-known film thickness measurement method. As an example, a cross section of the magnetic recording medium in a thickness direction is exposed by a well-known method of ion beams or microtome, and the exposed cross section is observed with a transmission electron microscope or a scanning electron microscope. In the cross section observation, various thicknesses can be obtained as the thickness obtained at one portion, or as an arithmetic mean of thicknesses obtained at a plurality of portions which are two or more portions randomly extracted, for example, two portions. Alternatively, the thickness of each layer may be obtained as a designed thickness calculated under the manufacturing conditions.

### Manufacturing Step

A step of preparing the composition for forming the magnetic layer, the non-magnetic layer, or the back coating layer can generally include at least a kneading step, a dispersing step, and a mixing step provided before and after these steps, as necessary. Each step may be divided into two or more stages. Components used in the preparation of each layer forming composition may be added at the beginning or during any step. As the solvent, one kind or two or more kinds of various kinds of solvents usually used for producing a coating type magnetic recording medium can be used. For the solvent, descriptions disclosed in paragraph 0153 of JP2011-216149A can be referred to, for example. In addition, each component may be separately added in two or more steps. In order to manufacture the above magnetic recording medium, a well-known manufacturing technology of the related art can be used in various steps. In the kneading step, an open kneader, a continuous kneader, a pressure kneader, or a kneader having a strong kneading force such as an extruder is preferably used. For details of the kneading processes, descriptions disclosed in JP1989-106338A (JP-H01-106338A) and JP1989-079274A (JP-H01-079274A) can be referred to. As a disperser, a well-known disperser can be used. Each layer forming composition may be filtered by a well-known method before performing the coating step. The filtering can be performed by using a filter, for example. As the filter used in the filtering, a filter having a hole diameter of 0.01 to 3 μm (for example, filter made of glass fiber or filter made of polypropylene) can be used, for example.

In one embodiment, in the step of preparing the magnetic layer forming composition, a dispersion liquid including a projection formation agent (hereinafter, referred to as a “projection formation agent liquid”) can be prepared, and then this projection formation agent liquid can be mixed with one or more other components of the magnetic layer forming composition. For example, the projection formation agent liquid, a dispersion liquid including an abrasive (hereinafter, referred to as an “abrasive solution”), and a dispersion liquid including a ferromagnetic powder (hereinafter, referred to as a “magnetic liquid”) are separately prepared, mixed, and dispersed, thereby preparing the magnetic layer forming composition. It is preferable to separately prepare various dispersion liquids in order to improve the dispersibility of the ferromagnetic powder, the projection formation agent, and the abrasive in the magnetic layer forming composition. For example, the projection formation agent liquid can be prepared by a well-known dispersion process such as ultrasonic treatment. The ultrasonic treatment can be performed for about 1 to 300 minutes at an ultrasonic output of about 10 to 2,000 watts per 200 cc (1 cc=1 cm³). In addition, the filtering may be performed after a dispersion process. For the filter used for the filtering, the above description can be referred to.

The magnetic layer can be formed by directly applying the magnetic layer forming composition onto the non-magnetic support or performing multilayer coating of the magnetic layer forming composition with the non-magnetic layer forming composition in order or at the same time. For details of the coating for forming each layer, a description disclosed in a paragraph 0066 of JP2010-231843A can be referred to.

After the coating step, various processes such as a drying process, an alignment process of a magnetic layer, and a surface smoothing process (calender process) can be performed. For details of the various processes, a well-known technology disclosed in paragraphs 0052 to 0057 of JP2010-024113A can be referred to, for example. For example, the coating layer of the magnetic layer forming composition can be subjected to an alignment process, while the coating layer is wet. For the alignment process, various well-known technologies such as descriptions disclosed in a paragraph 0067 of JP2010-231843A can be used. For example, a homeotropic alignment process can be performed by a well-known method such as a method using a different polar opposing magnet. In the alignment zone, a drying speed of the coating layer can be controlled by a temperature, an air flow of the warm air and/or a transportation rate of the non-magnetic support on which the coating layer is formed in the alignment zone. In addition, the coating layer may be preliminarily dried before transporting to the alignment zone.

The magnetic recording medium according to an embodiment of the invention can be a tape-shaped magnetic recording medium (magnetic tape), and may be a disk-shaped magnetic recording medium (magnetic disk). For example, the magnetic tape is normally accommodated in a magnetic tape cartridge and the magnetic tape cartridge is mounted on a magnetic recording and reproducing device. A servo pattern can be formed on the magnetic recording medium by a well-known method, in order to perform head tracking in the magnetic recording and reproducing device. The “formation of the servo pattern” can be “recording of a servo signal”. Hereinafter, the formation of the servo pattern will be described using a magnetic tape as an example.

The servo pattern is generally formed along a longitudinal direction of the magnetic tape. As a method of control using a servo signal (servo control), timing-based servo (TBS), amplitude servo, or frequency servo is used.

As shown in European Computer Manufacturers Association (ECMA)-319 (June 2001), a timing-based servo system is used in a magnetic tape based on a linear-tape-open (LTO) standard (generally referred to as an “LTO tape”). In this timing-based servo system, the servo pattern is configured by continuously disposing a plurality of pairs of magnetic stripes (also referred to as “servo stripes”) not parallel to each other in a longitudinal direction of the magnetic tape. As described above, a reason for that the servo pattern is configured with one pair of magnetic stripes not parallel to each other is because a servo signal reading element passing on the servo pattern recognizes a passage position thereof. Specifically, one pair of the magnetic stripes are formed so that a gap thereof is continuously changed along the width direction of the magnetic tape, and a relative position of the servo pattern and the servo signal reading element can be recognized, by the reading of the gap thereof by the servo signal reading element. The information of this relative position can realize the tracking of a data track. Accordingly, a plurality of servo tracks are generally set on the servo pattern along the width direction of the magnetic tape.

The servo band is configured of a servo signal continuous in the longitudinal direction of the magnetic tape. A plurality of servo bands are normally provided on the magnetic tape. For example, the number thereof is 5 in the LTO tape. A region interposed between two adjacent servo bands is called a data band. The data band is configured of a plurality of data tracks and each data track corresponds to each servo track.

In one embodiment, as shown in JP2004-318983A, information showing the number of servo band (also referred to as “servo band identification (ID)” or “Unique Data Band Identification Method (UDIM) information”) is embedded in each servo band. This servo band ID is recorded by shifting a specific servo stripe among the plurality of pair of servo stripes in the servo band so that the position thereof is relatively deviated in the longitudinal direction of the magnetic tape. Specifically, the position of the shifted specific servo stripe among the plurality of pair of servo stripes is changed for each servo band. Accordingly, the recorded servo band ID is unique for each servo band, and therefore, the servo band can be uniquely specified by only reading one servo band by the servo signal reading element.

In a method of uniquely specifying the servo band, a staggered method as shown in ECMA-319 (June 2001) is used. In this staggered method, a plurality of the groups of one pair of magnetic stripes (servo stripe) not parallel to each other which are continuously disposed in the longitudinal direction of the magnetic tape is recorded so as to be shifted in the longitudinal direction of the magnetic tape for each servo band. A combination of this shifted servo band between the adjacent servo bands is set to be unique in the entire magnetic tape, and accordingly, the servo band can also be uniquely specified by reading of the servo pattern by two servo signal reading elements.

In addition, as shown in ECMA-319 (June 2001), information showing the position in the longitudinal direction of the magnetic tape (also referred to as “Longitudinal Position (LPOS) information”) is normally embedded in each servo band. This LPOS information is recorded so that the position of one pair of servo stripes are shifted in the longitudinal direction of the magnetic tape, in the same manner as the UDIM information. However, unlike the UDIM information, the same signal is recorded on each servo band in this LPOS information.

Other information different from the UDIM information and the LPOS information can be embedded in the servo band. In this case, the embedded information may be different for each servo band as the UDIM information, or may be common in all of the servo bands, as the LPOS information.

In addition, as a method of embedding the information in the servo band, a method other than the method described above can be used. For example, a predetermined code may be recorded by thinning out a predetermined pair among the group of pairs of the servo stripes.

A servo pattern forming head is also referred to as a servo write head. The servo write head includes pairs of gaps corresponding to the pairs of magnetic stripes by the number of servo bands. In general, a core and a coil are respectively connected to each of the pairs of gaps, and a magnetic field generated in the core can generate leakage magnetic field in the pairs of gaps, by supplying a current pulse to the coil. In a case of forming the servo pattern, by inputting a current pulse while causing the magnetic tape to run on the servo write head, the magnetic pattern corresponding to the pair of gaps is transferred to the magnetic tape, and the servo pattern can be formed. A width of each gap can be suitably set in accordance with a density of the servo patterns to be formed. The width of each gap can be set as, for example, equal to or smaller than 1 μm, 1 to 10 μm, or equal to or greater than 10 μm.

Before forming the servo pattern on the magnetic tape, a demagnetization (erasing) process is generally performed on the magnetic tape. This erasing process can be performed by applying a uniform magnetic field to the magnetic tape by using a direct current magnet and an alternating current magnet. The erasing process includes direct current (DC) erasing and alternating current (AC) erasing. The AC erasing is performed by slowing decreasing an intensity of the magnetic field, while reversing a direction of the magnetic field applied to the magnetic tape. Meanwhile, the DC erasing is performed by adding the magnetic field in one direction to the magnetic tape. The DC erasing further includes two methods. A first method is horizontal DC erasing of applying the magnetic field in one direction along a longitudinal direction of the magnetic tape. A second method is vertical DC erasing of applying the magnetic field in one direction along a thickness direction of the magnetic tape. The erasing process may be performed with respect to all of the magnetic tape or may be performed for each servo band of the magnetic tape.

A direction of the magnetic field to the servo pattern to be formed is determined in accordance with the direction of erasing. For example, in a case where the horizontal DC erasing is performed to the magnetic tape, the formation of the servo pattern is performed so that the direction of the magnetic field and the direction of erasing is opposite to each other. Accordingly, the output of the servo signal obtained by the reading of the servo pattern can be increased. As disclosed in JP2012-053940A, in a case where the magnetic pattern is transferred to the magnetic tape subjected to the vertical DC erasing by using the gap, the servo signal obtained by the reading of the formed servo pattern has a unipolar pulse shape. Meanwhile, in a case where the magnetic pattern is transferred to the magnetic tape subjected to the horizontal DC erasing by using the gap, the servo signal obtained by the reading of the formed servo pattern has a bipolar pulse shape.

The magnetic tape is normally accommodated in a magnetic tape cartridge and the magnetic tape cartridge is mounted on a magnetic recording and reproducing device.

### Magnetic Tape Cartridge

One aspect of the invention relates to a magnetic tape cartridge including the tape-shaped magnetic recording medium (that is, magnetic tape).

The details of the magnetic tape included in the magnetic tape cartridge are as described above.

In the magnetic tape cartridge, the magnetic tape is generally accommodated in a cartridge main body in a state of being wound around a reel. The reel is rotatably provided in the cartridge main body. As the magnetic tape cartridge, a single reel type magnetic tape cartridge including one reel in a cartridge main body and a twin reel type magnetic tape cartridge including two reels in a cartridge main body are widely used. In a case where the single reel type magnetic tape cartridge is mounted in the magnetic recording and reproducing device in order to record and/or reproduce data on the magnetic tape, the magnetic tape is drawn from the magnetic tape cartridge and wound around the reel on the magnetic recording and reproducing device side. A magnetic head is disposed on a magnetic tape transportation path from the magnetic tape cartridge to a winding reel. Sending and winding of the magnetic tape are performed between a reel (supply reel) on the magnetic tape cartridge side and a reel (winding reel) on the magnetic recording and reproducing device side. In the meantime, the magnetic head comes into contact with and slides on the surface of the magnetic layer side of the magnetic tape, and accordingly, the recording and/or reproduction of data is performed. With respect to this, in the twin reel type magnetic tape cartridge, both reels of the supply reel and the winding reel are provided in the magnetic tape cartridge. The magnetic tape cartridge may be any of single reel type magnetic tape cartridge and twin reel type magnetic tape cartridge. The magnetic tape cartridge may include the magnetic tape according to the embodiment of the invention, and well-known technologies can be applied for the other configurations. A total length of the magnetic tape accommodated in the magnetic tape cartridge can be, for example, 800 m or more, and can be in a range of approximately 800 m to 2,000 m. The longer the total length of the tape accommodated in the magnetic tape cartridge is, the preferable it is from a viewpoint of increasing the capacity of the magnetic tape cartridge. Meanwhile, as described above, the longer the total length of the magnetic tape accommodated in the magnetic tape cartridge, the more easily the magnetic properties of the ε-iron oxide powder deteriorate in the magnetic tape cartridge, and it is considered that the electromagnetic conversion characteristics after long-term storage described above tend to deteriorate. On the other hand, in the magnetic recording medium, the inventors considers that the SQ after pressing in the range described above contributes to prevention of such a deterioration in electromagnetic conversion characteristics.

### Magnetic Recording and Reproducing Device

According to still another aspect of the invention, there is provided a magnetic recording and reproducing device including the magnetic recording medium described above.

In the invention and the specification, the “magnetic recording and reproducing device” means a device capable of performing at least one of the recording of data on the magnetic recording medium or the reproducing of data recorded on the magnetic recording medium. Such a device is generally called a drive. The magnetic recording and reproducing device can be a sliding type magnetic recording and reproducing device. The sliding type magnetic recording and reproducing device is a device in which the surface of the magnetic layer side and the magnetic head are in contact with each other and slide, in a case of performing recording of data on the magnetic recording medium and/or reproducing of the recorded data. For example, the magnetic recording and reproducing device can attachably and detachably include the magnetic tape cartridge.

The magnetic recording and reproducing device may include a magnetic head. The magnetic head can be a recording head capable of performing the recording of data on the magnetic tape, and can also be a reproducing head capable of performing the reproducing of data recorded on the magnetic tape. In addition, in the embodiment, the magnetic recording and reproducing device can include both of a recording head and a reproducing head as separate magnetic heads. In another embodiment, the magnetic head included in the magnetic recording and reproducing device can also have a configuration of comprising both of an element for recording data (recording element) and an element for reproducing data (reproducing element) in one magnetic head. Hereinafter, the element for recording data and the element for reproducing are collectively referred to as “elements for data”. As the reproducing head, a magnetic head (MR head) including a magnetoresistive (MR) element capable of reading data recorded on the magnetic tape with excellent sensitivity as the reproducing element is preferable. As the MR head, various well-known MR heads such as an Anisotropic Magnetoresistive (AMR) head, a Giant Magnetoresistive (GMR) head, or a Tunnel Magnetoresistive (TMR) can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing device. For example, the magnetic head which performs the recording of data and/or reproducing of the recorded data (hereinafter, also referred to as a “recording and reproducing head”) can include two servo signal reading elements, and each of the two servo signal reading elements can read two adjacent servo bands at the same time. One or a plurality of elements for data can be disposed between the two servo signal reading elements.

In the magnetic recording and reproducing device, the recording of data on the magnetic recording medium and/or the reproducing of data recorded on the magnetic recording medium can be performed by bringing the surface of the magnetic layer side of the magnetic recording medium into contact with the magnetic head and sliding. The magnetic recording and reproducing device may include the magnetic recording medium according to the embodiment of the invention, and well-known technologies can be applied for the other configurations.

For example, in a case of recording data and/or reproducing the recorded data, first, tracking using a servo signal is performed. That is, as the servo signal reading element follows a predetermined servo track, the element for data is controlled to pass on the target data track. The movement of the data track is performed by changing the servo track to be read by the servo signal reading element in the tape width direction.

In addition, the recording and reproducing head can also perform the recording and/or reproducing with respect to other data bands. In this case, the servo signal reading element is moved to a predetermined servo band by using the UDIM information described above, and the tracking with respect to the servo band may be started.

### EXAMPLES

Hereinafter, the invention will be described with reference to examples. However, the invention is not limited to the embodiments shown in the examples. “Parts” and “%” in the following description mean “parts by mass” and “% by mass”, unless otherwise noted. “eq” indicates equivalent and is a unit not convertible into SI unit. In addition, steps and evaluations described below are performed in an environment of an ambient temperature of 23° C.±1° C., unless otherwise noted.

### ε-Iron Oxide Powder

The various ε-iron oxide powders shown in Table 1 which will be described later are ε-iron oxide powders produced by the following method.

### Method for Producing ε-Iron Oxide Powder No. 1

44.0 g of ammonia aqueous solution having a concentration of 25% was added to a material obtained by dissolving iron (III) nitrate nonahydrate (added amount: “amount of Fe nitrate” in Table 1), gallium (III) nitrate octahydrate (added amount: “amount of Ga nitrate” in Table 1), cobalt (II) nitrate hexahydrate (added amount: “amount of Co nitrate” in Table 1), titanium (IV) sulfate (added amount: “amount of Ti sulfate” in Table 1), and 16.7 g of polyvinylpyrrolidone (PVP) in 1,000 g of pure water, while stirring by using a magnetic stirrer, in an atmosphere under the conditions of an ambient temperature of 25° C., and the mixture was stirred for 2 hours still under the temperature condition of the ambient temperature of 25° C. A citric acid aqueous solution obtained by dissolving 11 g of citric acid in 100 g of pure water was added to the obtained solution and stirred for 1 hour. The powder precipitated after the stirring was collected by centrifugal separation, washed with pure water, and dried in a heating furnace at a furnace inner temperature of 80° C.

8,900 g of pure water was added to the dried powder and the powder was dispersed in water again, to obtain a dispersion liquid. The obtained dispersion liquid was heated to a liquid temperature of 50° C., and 440 g of ammonia aqueous solution having a concentration of 25% was added dropwise while stirring. The stirring was performed for 1 hour while holding the temperature of 50° C., and 160 mL of tetraethoxysilane (TEOS) was added dropwise and stirred for 24 hours. 500 g of ammonium sulfate was added to the obtained reaction solution, the precipitated powder was collected by centrifugal separation, washed with pure water, and dried in a heating furnace at a furnace inner temperature of 80° C. for 24 hours, and a precursor of ferromagnetic powder was obtained.

The heating furnace at a furnace inner temperature shown in Table 1 was loaded with the obtained precursor of ferromagnetic powder in the atmosphere and subjected to heat treatment for 4 hours.

The powder after the heat treatment was put into a 4 mol/L aqueous solution of sodium hydroxide (NaOH) and stirred while maintaining the liquid temperature at 70° C. for 24 hours, and the coating film removal step was carried out.

Then, the powder subjected to the coating film removing step was collected by centrifugal separation process and washed with pure water.

5 g of the powder obtained after the pure water washing, 2.0 g of citric acid, 150 g of zirconia beads, and 25 g of pure water were placed in a closed container and dispersed with a paint shaker for 4.0 hours. Then, 180 g of pure water was added to separate the beads from the liquid, and these were separated by centrifugal separation to precipitate the ferromagnetic powder, and then the supernatant liquid was removed.

Then, the classification process was performed by the following method.

The ferromagnetic powder precipitated above was mixed with 190 g of pure water, dispersed with a homogenizer again, the pH was adjusted to 10.0 with aqueous ammonia having a concentration of 25%, and the dispersion liquid of ferromagnetic powder particles was obtained. The obtained dispersion liquid was subjected to the first centrifugal separation process by applying a centrifugal force of 15,200 G (gravitational acceleration) using a centrifuge (process time: see Table 1), and then the precipitate and the supernatant liquid were separated by decantation.

Next, the obtained supernatant liquid was subjected to the second centrifugal separation process by applying a centrifugal force of 15,200 G using a centrifuge (process time: see Table 1), and then the supernatant liquid and the precipitate were separated by decantation.

The obtained precipitate was washed with pure water and dried in a dryer at an internal ambient temperature of 95° C. for 24 hours to obtain a ferromagnetic powder.

The composition of the ferromagnetic powder obtained through the above steps was confirmed by Inductively Coupled Plasma-Optical Emission Spectrometry (ICP-OES), and Ga, Co, and Ti substitution type ε-iron oxide (composition of ε-iron oxide: see Table 1) was obtained. In addition, a CuKα ray was scanned under the conditions of a voltage 45 kV and intensity of 40 mA, the X-ray diffraction pattern was measured under the following conditions (X-ray diffraction analysis), and it was confirmed that the obtained ferromagnetic powder has a crystal structure of a single phase which is an ε phase not including a crystal structure of an a phase and a γ phase (ε-iron oxide type crystal structure) from the peak of the X-ray diffraction pattern.

PANalytical X'Pert Pro diffractometer, PIXcel detector Soller slit of incident beam and diffraction beam: 0.017 radians

Fixed angle of dispersion slit: ¼ degrees

Mask: 10 mm

Scattering prevention slit: ¼ degrees

Measurement mode: continuous

Measurement time per 1 stage: 3 seconds

Measurement speed: 0.017 degrees per second

Measurement step: 0.05 degree

### Method for Producing ε-Iron Oxide Powders No. 2 to No. 11

Each of ε-iron oxide powders No. 2 to No. 11 was produced in the same manner as described above, except that the items shown in Table 1 were changed as shown in Table 1. The analysis results of the composition are shown in Table 1. The X-ray diffraction analysis of the ε-iron oxide powders No. 2 to No. 11 was performed in the same manner as described above, and it was confirmed that each powder had a crystal structure of a single phase which is an ε phase (ε-iron oxide type crystal structure).

### Projection formation agent

The projection formation agent shown in Table 1 which will be described later is as follows. A projection formation agent 1 and a projection formation agent 3 are particles having a low surface smoothness of a surface of particles. A particle shape of a projection formation agent 2 is a shape of a cocoon. A particle shape of a projection formation agent 4 is a so-called unspecified shape. A particle shape of a projection formation agent 5 is a shape closer to a sphere.

Projection formation agent 1: ATLAS (composite particles of silica and polymer) manufactured by Cabot Corporation, average particle size: 100 nm

Projection formation agent 2: TGC6020N (silica particles) manufactured by Cabot Corporation, average particle size: 140 nm

Projection formation agent 3: Cataloid (water dispersed sol of silica particles; as a projection formation agent for preparing a projection formation agent liquid, a dried solid material obtained by removing the solvent by heating the water dispersed sol described above is used) manufactured by JGC c&c, average particle size: 120 nm

Projection formation agent 4: ASAHI #50 (carbon black) manufactured by Asahi Carbon Co., Ltd., average particle size: 300 nm

Projection formation agent 5: PL-10L (water dispersed sol of silica particles; as a projection formation agent for preparing a projection formation agent liquid, a dried solid material obtained by removing the solvent by heating the water dispersed sol described above is used) manufactured by FUSO CHEMICAL CO., LTD., average particle size: 130 nm

### Example 1-1

Magnetic Layer Forming Composition

Magnetic Liquid

ε-Iron Oxide Powder (see Table 1): 100.0 parts

A sulfonic acid group-containing polyurethane resin: 15.0 parts

Cyclohexanone: 150.0 parts

Methyl ethyl ketone: 150.0 parts

Abrasive Solution

α-alumina (Average particle size: 110 nm): 9.0 parts

Vinyl chloride copolymer (MR 110 manufactured by Kaneka Corporation): 0.7 parts

Cyclohexanone: 20.0 parts

Projection formation agent liquid

Projection formation agent (see Table 1): 1.3 parts

Methyl ethyl ketone: 9.0 parts

Cyclohexanone: 6.0 parts

### Other Components

Butyl stearate: 1.0 part

Stearic acid: 1.0 part

Polyisocyanate (CORONATE manufactured by Tosoh Corporation): 2.5 parts

Finishing Additive Solvent

Cyclohexanone: 180.0 parts

Methyl ethyl ketone: 180.0 parts

### Non-Magnetic Layer Forming Composition

Non-magnetic inorganic powder (α-iron oxide): 80.0 parts

(Average particle size: 0.15 μm, average acicular ratio: 7, Brunauer-Emmett-Teller (BET) specific surface area: 52 m²/g)

Carbon black (average particle size: 20 nm): 20.0 parts

Electron ray curable vinyl chloride copolymer: 13.0 parts

Electron beam curable polyurethane resin: 6.0 parts

Phenylphosphonic acid: 3.0 parts

Cyclohexanone: 140.0 parts

Methyl ethyl ketone: 170.0 parts

Butyl stearate: 4.0 parts

Stearic acid: 1.0 part

### Back Coating Layer Forming Composition

Non-magnetic inorganic powder (α-iron oxide): 80.0 parts (Average particle size: 0.15 μm, average acicular ratio: 7, BET specific surface area: 52 m²/g)

Carbon black (average particle size: 20 nm): 20.0 parts

Carbon black (average particle size: 100 nm): 3.0 parts

A vinyl chloride copolymer: 13.0 parts

A sulfonic acid group-containing polyurethane resin: 6.0 parts

Phenylphosphonic acid: 3.0 parts

Cyclohexanone: 140.0 parts

Methyl ethyl ketone: 170.0 parts

Stearic acid: 3.0 parts

Polyisocyanate (CORONATE manufactured by Tosoh Corporation): 5.0 parts

Methyl ethyl ketone: 400.0 parts

### Preparation of Each Layer Forming Composition

The magnetic layer forming composition was prepared by the following method.

Various components of the magnetic liquid were kneaded by an open kneader and diluted, and was subjected to a dispersion process of 12 passes, with a transverse beads mill disperser and zirconia (ZrO₂) beads having a bead diameter of 0.5 mm (hereinafter, referred to as “Zr beads”), by setting a bead filling percentage as 80 volume %, a circumferential speed of rotor distal end as 10 m/sec, and a retention time for 1 pass as 2 minutes, to prepare the magnetic liquid.

After mixing various components of the abrasive solution described above, this was put into a vertical sand mill disperser together with Zr beads having a bead diameter of 1 mm, a proportion of a bead volume with respect to a total of an abrasive solution volume and a bead volume was adjusted to 60%, and the sand mill dispersion process was performed for 180 minutes. The liquid after the sand mill dispersion process was taken out and subjected to the ultrasonic dispersion filtration treatment using a flow type ultrasonic dispersion filtering device to prepare an abrasive solution.

The projection formation agent liquid was prepared by filtering a dispersion liquid obtained by mixing various components of the above-mentioned projection formation agent liquid and then ultrasonically treating (dispersion process) for 60 minutes with an ultrasonic output of 500 watts per 200 cc by a horn-type ultrasonic dispersing device with a filter having a hole diameter of 0.5 μm.

The magnetic liquid, the projection formation agent liquid, the abrasive solution, the other components, and the finishing additive solvent were introduced into a dissolver stirrer, and stirred at a circumferential speed of 10 m/sec for 30 minutes. Then, after performing the process 2 times of pass with a flow type ultrasonic disperser at a flow rate of 7.5 kg/min, the magnetic layer forming composition was prepared by filtering once with a filter having a hole diameter of 1.0 μm.

The non-magnetic layer forming composition was prepared by the following method.

The components excluding the lubricant (butyl stearate and stearic acid) were kneaded and diluted with an open kneader, and then dispersed with a transverse beads mill disperser. Then, the lubricant (butyl stearate and stearic acid) was added, and the mixture was stirred and mixed with a dissolver stirrer to prepare a non-magnetic layer forming composition.

The back coating layer forming composition was prepared by the following method.

The components excluding the lubricant (stearic acid), polyisocyanate, and methyl ethyl ketone (400.0 parts) were kneaded and diluted with an open kneader, and then dispersed with a transverse beads mill disperser. Then, the lubricant (stearic acid), polyisocyanate, and methyl ethyl ketone (400.0 parts) were added, and the mixture was stirred and mixed with a dissolver stirrer to prepare a back coating layer forming composition.

### Manufacturing of Magnetic Tape

The non-magnetic layer forming composition was applied to a surface of a biaxial stretching support made of polyethylene naphthalate having a thickness of 5.0 μm so that the thickness after the drying is 1.0 μm and was dried to emit an electron ray to have energy of 40 kGy at an acceleration voltage of 125 kV. The magnetic layer forming composition was applied thereon so that the thickness after the drying is 0.1 μm, and a coating layer was formed. A homeotropic alignment process was performed by applying a magnetic field having a magnetic field strength of 0.3 T in a vertical direction with respect to a surface of a coating layer, in the alignment zone, while the coating layer of the magnetic layer forming composition is wet. Then, the drying was performed to form the magnetic layer. After that, the back coating layer forming composition as described above was applied to the surface of the support opposite to the surface where the non-magnetic layer and the magnetic layer were formed, so that the thickness after the drying becomes 0.5 μm, and was dried to form a back coating layer.

Then, a surface smoothing process (calender process) was performed by using a calender roll configured of only a metal roll, at a calender process speed of 80 m/min, linear pressure of 300 kg/cm (294 kN/m), and a surface temperature of a calender roll of 110° C.

Then, the heat treatment was performed in the environment of the ambient temperature of 70° C. for 36 hours. After heat treatment, the slitting was performed to have a width of ½ inches (0.0127 meters), the surface of the magnetic layer was cleaned with a tape cleaning device attached to a device including a device for sending and winding of a slit product so that a non-woven fabric and a razor blade were in contact with the surface of the magnetic layer, and a servo pattern having arrangement and a shape according to linear tape-open (LTO) Ultrium format was formed by a servo write head mounted on a servo writer, in a state where the magnetic layer of the magnetic tape was demagnetized.

Accordingly, a magnetic tape including data bands, servo bands, and guide bands in the disposition according to the LTO Ultrium format in the magnetic layer, and including servo patterns having the disposition and the shape according to the LTO Ultrium format on the servo band was obtained.

### Examples 1-2 to 1-9, Examples 2-1 to 2-9, Examples 3-1 to 3-9, and Comparative Examples 1 to 12

A magnetic tape was produced in the same manner as described above, except that items shown in Table 1 were changed as shown in Table 1.

In the examples and the comparative examples, two magnetic tapes were produced, one was used for the evaluation of (1) below, and the other was used for the evaluation of (2) below.

### Evaluation Method

### (1) SQ after pressing

Each magnetic tape of the examples and the comparative examples was passed between two rolls (without heating the rolls) six times in total while running the magnetic tape in a longitudinal direction at a speed of 20 m/min in a state where a tension of 0.5 N/m was applied, by using a calender treatment device including a 7-step calender roll configured of only a metal roll in an environment of an ambient temperature of 20° C. to 25° C. and relative humidity of 40% to 60%, and accordingly, the pressing was performed by applying a surface pressure of 70 atm to the surface of each magnetic layer, during the passing between each roll.

A sample piece was cut out from the magnetic tape after the pressing. For this sample piece, a vertical squareness ratio SQ (that is, SQ after pressing) was obtained by the method described above using a TM-TRVSM5050-SMSL type manufactured by Tamagawa Seisakusho Co., Ltd. as a vibrating sample magnetometer.

### (2) Evaluation of the amount of SNR reduction after pressing at pressure of 70 atm

For each of the magnetic tapes of the examples and the comparative examples, a Signal-to-Noise-ratio (SNR) was measured by the following method.

Then, after pressing at 70 atm by the same method as described in (1) above, the SNR was measured in the same manner. The difference between the SNR values before and after pressing (SNR before pressing-SNR after pressing) thus obtained was calculated. The calculated values are shown in the “SNR reduction” column in Table 1.

A ½-inch reel tester with a fixed magnetic head was used, and a running speed of the magnetic tape (relative speed between the magnetic head and the magnetic tape) was set to 4 m/sec. A Metal-In-Gap (MIG) head (gap length: 0.15 μm, track width: 1.0 μm) was used as the recording head, and a recording current was set to the optimum recording current of each magnetic tape. As the reproducing head, a Giant-Magnetoristive (GMR) head having an element thickness of 15 nm, a shield interval of 0.1 μm, and a lead width of 0.5 μm was used. The signal was recorded at a linear recording density of 300 kfci, and the reproduced signal was measured with a spectrum analyzer manufactured by Advantest Corporation. In addition, the unit kfci is a unit of linear recording density (cannot be converted to SI unit system). A ratio of the output value of the carrier signal to the integrated noise in the entire spectrum was defined as SNR. In order to measure the SNR, a sufficiently stabilized signal was used after the running of the magnetic tape was started.

The result described above is shown in Table 1 (Tables 1-1 to 1-5).

TABLE 1-1

| | | | | Example 1-1 | Example 1-2 | Example 1-3 | Example 1-4 |
|---|---|---|---|---|---|---|---|
| | | | | Projection | Projection | Projection | Projection |
| | | | Unit | formation | formation | formation | formation |
| Projection formation agent | | | — | agent 1 | agent 1 | agent 1 | agent 1 |
| ε-iron oxide | No. | | — | 1 | 2 | 3 | 4 |
| powder | Raw | Amount of | g | 92.2 | 92.2 | 92.2 | 92.2 |
| | material | Fe nitrate | | | | | |
| | | Amount of | g | 14.4 | 14.4 | 14.4 | 14.4 |
| | | Ga nitrate | | | | | |
| | | Amount of | g | 2.1 | 2.1 | 2.1 | 2.1 |
| | | Co nitrate | | | | | |
| | | Amount of | g | 1.7 | 1.7 | 1.7 | 1.7 |
| | | Ti sulfate | | | | | |
| | Furnace inner temperature | | ° C. | 1000 | 1000 | 1015 | 1015 |
| | during heat treatment | | | | | | |
| | Centrifugal | Time of first | min | 220 | 240 | 150 | 160 |
| | separation | centrifugal | | | | | |
| | | separation | | | | | |
| | | Time of second | min | 360 | 320 | 240 | 210 |
| | | centrifugal | | | | | |
| | | separation | | | | | |

| | | | | | | |
|---|---|---|---|---|---|---|
| | Composition | Fe:Ga:CO:Ti | 1.62:0.28:0.05:0.05 | 1.62:0.28:0.05:0.05 | 1.62:0.28:0.05:0.05 | 1.62:0.28:0.05:0.05 |
| | Average particle size | nm | 11.5 | 11.4 | 13.2 | 13.3 |
| Physical | SQ after pressing | — | 0.63 | 0.71 | 0.65 | 0.73 |
| properties | | | | | | |
| Performance | SNR reduction | dB | 1.0 | 0.9 | 1.1 | 1.0 |

| | | | Example 1-5 | Example 1-6 | Example 1-7 | Example 1-8 | Example 1-9 |
|---|---|---|---|---|---|---|---|
| | | | Projection | Projection | Projection | Projection | Projection |
| | | | formation | formation | formation | formation | formation |
| Projection formation agent | | | agent 1 | agent 1 | agent 1 | agent 1 | agent 1 |
| ε-iron oxide | No. | | 5 | 6 | 7 | 8 | 11 |
| powder | Raw | Amount of | 96.8 | 96.8 | 92.8 | 92.8 | 96.8 |
| | material | Fe nitrate | | | | | |
| | | Amount of | 10.3 | 10.3 | 19.0 | 19.0 | 15.4 |
| | | Ga nitrate | | | | | |
| | | Amount of | 2.1 | 2.1 | 0.0 | 0.0 | 0.0 |
| | | Co nitrate | | | | | |
| | | Amount of | 1.7 | 1.7 | 0.0 | 0.0 | 0.0 |
| | | Ti sulfate | | | | | |

| Furnace inner temperature | | 980 | 980 | 1020 | 1020 | 1050 |
|---|---|---|---|---|---|---|
| during heat treatment | | | | | | |
| Centrifugal | Time of first | 280 | 300 | 110 | 120 | 110 |
| separation | centrifugal | | | | | |
| | separation | | | | | |
| | Time of second | 450 | 400 | 180 | 160 | 120 |
| | centrifugal | | | | | |
| | separation | | | | | |

| | | | | | | |
|---|---|---|---|---|---|---|
| | Composition | 1.70:0.20:0.05:0.05 | 1.70:0.20:0.05:0.05 | 1.63:0.37:0:0 | 1.63:0.37:0:0 | 1.70:0.30:0:0 |
| | Average particle size | 9.8 | 9.7 | 14.6 | 14.2 | 17.8 |
| Physical | SQ after pressing | 0.58 | 0.62 | 0.68 | 0.75 | 0.93 |
| properties | | | | | | |
| Performance | SNR reduction | 1.0 | 0.9 | 1.1 | 1.0 | 1.5 |

TABLE 1-2

| | | | | Example 2-1 | Example 2-2 | Example 2-3 | Example 2-4 |
|---|---|---|---|---|---|---|---|
| | | | | Projection | Projection | Projection | Projection |
| | | | | formation | formation | formation | formation |
| Projection formation agent | | | Unit | agent 2 | agent 2 | agent 2 | agent 2 |
| ε-iron oxide | No. | | — | 1 | 2 | 3 | 4 |
| powder | Raw | Amount of | g | 92.2 | 92.2 | 92.2 | 92.2 |
| | material | Fe nitrate | | | | | |
| | | Amount of | g | 14.4 | 14.4 | 14.4 | 14.4 |
| | | Ga nitrate | | | | | |
| | | Amount of | g | 2.1 | 2.1 | 2.1 | 2.1 |
| | | Co nitrate | | | | | |
| | | Amount of | g | 1.7 | 1.7 | 1.7 | 1.7 |
| | | Ti sulfate | | | | | |
| | Furnace inner temperature | | ° C. | 1000 | 1000 | 1015 | 1015 |
| | during heat treatment | | | | | | |
| | Centrifugal | Time of first | min | 220 | 240 | 150 | 160 |
| | separation | centrifugal | | | | | |
| | | separation | | | | | |
| | | Time of second | min | 360 | 320 | 240 | 210 |
| | | centrifugal | | | | | |
| | | separation | | | | | |

| | | | | | | |
|---|---|---|---|---|---|---|
| | Composition | Fe:Ga:CO:Ti | 1.62:0.28:0.05:0.05 | 1.62:0.28:0.05:0.05 | 1.62:0.28:0.05:0.05 | 1.62:0.28:0.05:0.05 |
| | Average particle size | nm | 11.5 | 11.4 | 13.2 | 13.3 |
| Physical | SQ after pressing | — | 0.62 | 0.71 | 0.65 | 0.72 |
| properties | | | | | | |
| Performance | SNR reduction | dB | 1.2 | 1.0 | 1.2 | 1.1 |

| | | | Example 2-5 | Example 2-6 | Example 2-7 | Example 2-8 | Example 2-9 |
|---|---|---|---|---|---|---|---|
| | | | Projection | Projection | Projection | Projection | Projection |
| | | | formation | formation | formation | formation | formation |
| Projection formation agent | | | agent 2 | agent 2 | agent 2 | agent 2 | agent 2 |
| ε-iron oxide | No. | | 5 | 6 | 7 | 8 | 11 |
| powder | Raw | Amount of | 96.8 | 96.8 | 92.8 | 92.8 | 96.8 |
| | material | Fe nitrate | | | | | |
| | | Amount of | 10.3 | 10.3 | 19.0 | 19.0 | 15.4 |
| | | Ga nitrate | | | | | |
| | | Amount of | 2.1 | 2.1 | 0.0 | 0.0 | 0.0 |
| | | Co nitrate | | | | | |
| | | Amount of | 1.7 | 1.7 | 0.0 | 0.0 | 0.0 |
| | | Ti sulfate | | | | | |

| Furnace inner temperature | | 980 | 980 | 1020 | 1020 | 1050 |
|---|---|---|---|---|---|---|
| during heat treatment | | | | | | |
| Centrifugal | Time of first | 280 | 300 | 110 | 120 | 110 |
| separation | centrifugal | | | | | |
| | separation | | | | | |
| | Time of second | 450 | 400 | 180 | 160 | 120 |
| | centrifugal | | | | | |
| | separation | | | | | |

| | | | | | | |
|---|---|---|---|---|---|---|
| | Composition | 1.70:0.20:0.05:0.05 | 1.70:0.20:0.05:0.05 | 1.63:0.37:0:0 | 1.63:0.37:0:0 | 1.70:0.30:0:0 |
| | Average particle size | 9.8 | 9.7 | 14.6 | 14.2 | 17.8 |
| Physical | SQ after pressing | 0.56 | 0.61 | 0.68 | 0.74 | 0.92 |
| properties | | | | | | |
| Performance | SNR reduction | 1.1 | 1.0 | 1.2 | 1.1 | 1.5 |

TABLE 1-3

| | | | | Example 3-1 | Example 3-2 | Example 3-3 | Example 3-4 |
|---|---|---|---|---|---|---|---|
| | | | | Projection | Projection | Projection | Projection |
| | | | | formation | formation | formation | formation |
| Projection formation agent | | | Unit | agent 3 | agent 3 | agent 3 | agent 3 |
| ε-iron oxide | No. | | — | 1 | 2 | 3 | 4 |
| powder | Raw | Amount of | g | 92.2 | 92.2 | 92.2 | 92.2 |
| | material | Fe nitrate | | | | | |
| | | Amount of | g | 14.4 | 14.4 | 14.4 | 14.4 |
| | | Ga nitrate | | | | | |
| | | Amount of | g | 2.1 | 2.1 | 2.1 | 2.1 |
| | | Co nitrate | | | | | |
| | | Amount of | g | 1.7 | 1.7 | 1.7 | 1.7 |
| | | Ti sulfate | | | | | |
| | Furnace inner temperature | | ° C. | 1000 | 1000 | 1015 | 1015 |
| | during heat treatment | | | | | | |
| | Centrifugal | Time of first | min | 220 | 240 | 150 | 160 |
| | separation | centrifugal | | | | | |
| | | separation | | | | | |
| | | Time of second | min | 360 | 320 | 240 | 210 |
| | | centrifugal | | | | | |
| | | separation | | | | | |

| | | | | | | |
|---|---|---|---|---|---|---|
| | Composition | Fe:Ga:CO:Ti | 1.62:0.28:0.05:0.05 | 1.62:0.28:0.05:0.05 | 1.62:0.28:0.05:0.05 | 1.62:0.28:0.05:0.05 |
| | Average particle size | nm | 11.5 | 11.4 | 13.2 | 13.3 |
| Physical | SQ after pressing | — | 0.63 | 0.72 | 0.66 | 0.75 |
| properties | | | | | | |
| Performance | SNR reduction | dB | 1.0 | 0.9 | 1.0 | 1.0 |

| | | | Example 3-5 | Example 3-6 | Example 3-7 | Example 3-8 | Example 3-9 |
|---|---|---|---|---|---|---|---|
| | | | Projection | Projection | Projection | Projection | Projection |
| | | | formation | formation | formation | formation | formation |
| Projection formation agent | | | agent 3 | agent 3 | agent 3 | agent 3 | agent 3 |
| ε-iron oxide | No. | | 5 | 6 | 7 | 8 | 11 |
| powder | Raw | Amount of | 96.8 | 96.8 | 92.8 | 92.8 | 96.8 |
| | material | Fe nitrate | | | | | |
| | | Amount of | 10.3 | 10.3 | 19.0 | 19.0 | 15.4 |
| | | Ga nitrate | | | | | |
| | | Amount of | 2.1 | 2.1 | 0.0 | 0.0 | 0.0 |
| | | Co nitrate | | | | | |
| | | Amount of | 1.7 | 1.7 | 0.0 | 0.0 | 0.0 |
| | | Ti sulfate | | | | | |

| Furnace inner temperature | | 980 | 980 | 1020 | 1020 | 1050 |
|---|---|---|---|---|---|---|
| during heat treatment | | | | | | |
| Centrifugal | Time of first | 280 | 300 | 110 | 120 | 110 |
| separation | centrifugal | | | | | |
| | separation | | | | | |
| | Time of second | 450 | 400 | 180 | 160 | 120 |
| | centrifugal | | | | | |
| | separation | | | | | |

| | | | | | | |
|---|---|---|---|---|---|---|
| | Composition | 1.70:0.20:0.05:0.05 | 1.70:0.20:0.05.0.05 | 1.63:0.37:0:0 | 1.63:0.37:0:0 | 1.70:0.30:0:0 |
| | Average particle size | 9.8 | 9.7 | 14.6 | 14.2 | 17.8 |
| Physical | SQ after pressing | 0.59 | 0.62 | 0.69 | 0.75 | 0.93 |
| properties | | | | | | |
| Performance | SNR reduction | 1.0 | 0.9 | 1.1 | 0.9 | 1.4 |

TABLE 1-4

| | | | | Comparative | Comparative | Comparative |
|---|---|---|---|---|---|---|
| | | | | Example 1 | Example 2 | Example 3 |
| | | | | Projection | Projection | Projection |
| | | | Unit | formation | formation | formation |
| Projection formation agent | | | — | agent 4 | agent 5 | agent 4 |
| ε-iron oxide | No. | | — | 9 | 9 | 1 |
| powder | Raw | Amount of | g | 92.2 | 92.2 | 92.2 |
| | material | Fe nitrate | | | | |
| | | Amount of | g | 14.4 | 14.4 | 14.4 |
| | | Ga nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Furnace inner temperature | | ° C. | 1000 | 1000 | 1000 |
| | during heat treatment | | | | | |
| | Centrifugal | Time of first | min | — | — | 220 |
| | separation | centrifugal | | | | |
| | | separation | | | | |
| | | Time of second | min | — | — | 360 |
| | | centrifugal | | | | |
| | | separation | | | | |

| | | | | | |
|---|---|---|---|---|---|
| | Composition | Fe:Ga:CO:Ti | 1.62:0.28:0.05:0.05 | 1.62:0.28:0.05:0.05 | 1.62:0.28:0.05:0.05 |
| | Average particle size | nm | 11.4 | 11.4 | 11.5 |
| Physical | SQ after pressing | — | 0.37 | 0.39 | 0.44 |
| properties | | | | | |
| Performance | SNR reduction | dB | 5.0 | 5.2 | 4.6 |

| | | | Comparative | Comparative | Comparative |
|---|---|---|---|---|---|
| | | | Example 4 | Example 5 | Example 6 |
| | | | Projection | Projection | Projection |
| | | | formation | formation | formation |
| Projection formation agent | | | agent 5 | agent 4 | agent 5 |
| ε-iron oxide | No. | | 1 | 2 | 2 |
| powder | Raw | Amount of | 92.2 | 92.2 | 92.2 |
| | material | Fe nitrate | | | |
| | | Amount of | 14.4 | 14.4 | 14.4 |
| | | Ga nitrate | | | |
| | | Amount of | 2.1 | 2.1 | 2.1 |
| | | Co nitrate | | | |
| | | Amount of | 1.7 | 1.7 | 1.7 |
| | | Ti sulfate | | | |

| Furnace inner temperature | | 1000 | 1000 | 1000 |
|---|---|---|---|---|
| during heat treatment | | | | |
| Centrifugal | Time of first | 220 | 240 | 240 |
| separation | centrifugal | | | |
| | separation | | | |
| | Time of second | 360 | 320 | 320 |
| | centrifugal | | | |
| | separation | | | |

| | | | | |
|---|---|---|---|---|
| | Composition | 1.62:0.28:0.05:0.05 | 1.62:0.28:0.05:0.05 | 1.62:0.28:0.05:0.05 |
| | Average particle size | 11.5 | 11.4 | 11.4 |
| Physical | SQ after pressing | 0.45 | 0.48 | 0.47 |
| properties | | | | |
| Performance | SNR reduction | 4.4 | 4.1 | 4.0 |

TABLE 1-5

| | | | | Comparative | Comparative | Comparative |
|---|---|---|---|---|---|---|
| | | | | Example 7 | Example 8 | Example 9 |
| | | | | Projection | Projection | Projection |
| | | | Unit | formation | formation | formation |
| Projection formation agent | | | — | agent 1 | agent 2 | agent 3 |
| ε-iron oxide | — | | — | 9 | 9 | 9 |
| powder | Raw | Amount of | g | 92.2 | 92.2 | 92.2 |
| | material | Fe nitrate | | | | |
| | | Amount of | g | 14.4 | 14.4 | 14.4 |
| | | Ga nitrate | | | | |
| | | Amount of | g | 2.1 | 2.1 | 2.1 |
| | | Co nitrate | | | | |
| | | Amount of | g | 1.7 | 1.7 | 1.7 |
| | | Ti sulfate | | | | |
| | Furnace inner temperature | | ° C. | 1000 | 1000 | 1000 |
| | during heat treatment | | | | | |
| | Centrifugal | Time of first | min | — | — | — |
| | separation | centrifugal | | | | |
| | | separation | | | | |
| | | Time of second | min | — | — | — |
| | | centrifugal | | | | |
| | | separation | | | | |

| | | | | | |
|---|---|---|---|---|---|
| | Composition | Fe:Ga:CO:Ti | 1.62:0.28:0.05:0.05 | 1.62:0.28:0.05:0.05 | 1.62:0.28:0.05:0.05 |
| | Average particle size | nm | 11.4 | 11.4 | 11.4 |
| Physical | SQ after pressing | — | 0.46 | 0.45 | 0.45 |
| properties | | | | | |
| Performance | SNR reduction | OB | 4.6 | 4.4 | 4.4 |

| | | | Comparative | Comparative | Comparative |
|---|---|---|---|---|---|
| | | | Example 10 | Example 11 | Example 12 |
| | | | Projection | Projection | Projection |
| | | | formation | formation | formation |
| Projection formation agent | | | agent 1 | agent 2 | agent 3 |
| ε-iron oxide | — | | 10 | 10 | 10 |
| powder | Raw | Amount of | 96.8 | 96.8 | 96.8 |
| | material | Fe nitrate | | | |
| | | Amount of | 15.4 | 15.4 | 15.4 |
| | | Ga nitrate | | | |
| | | Amount of | 0.0 | 0.0 | 0.0 |
| | | Co nitrate | | | |
| | | Amount of | 0.0 | 0.0 | 0.0 |
| | | Ti sulfate | | | |

| Furnace inner temperature | | 1070 | 1070 | 1070 |
|---|---|---|---|---|
| during heat treatment | | | | |
| Centrifugal | Time of first | 100 | 100 | 100 |
| separation | centrifugal | | | |
| | separation | | | |
| | Time of second | 110 | 110 | 110 |
| | centrifugal | | | |
| | separation | | | |

| | | | | |
|---|---|---|---|---|
| | Composition | 1.70:0.30:0:0 | 1.70:0.30:0:0 | 1.70:0.30:0:0 |
| | Average particle size | 19.2 | 19.2 | 19.2 |
| Physical | SQ after pressing | 0.96 | 0.96 | 0.96 |
| properties | | | | |
| Performance | SNR reduction | 2.8 | 2.9 | 2.9 |

From the result shown in Table 1, it can be confirmed that, in the magnetic tapes of the examples, the deterioration in electromagnetic conversion characteristics was small after pressing at a pressure of 70 atm, that is, after being placed in a state corresponding to the state after the long-term storage, compared to the magnetic tapes of the comparative examples. According to this magnetic tape, even after the magnetic tape is accommodated in a state of being wound around a reel for a long period of time in the magnetic tape cartridge, after data with a low access frequency is recorded, the excellent electromagnetic conversion characteristics can be exhibited, and the magnetic tape is suitable as a recording medium for archive.

The one embodiment of the invention is effective for data storage.

What is claimed is:

1. A magnetic recording medium comprising:
a non-magnetic support; and
a magnetic layer containing a ferromagnetic powder,
wherein the ferromagnetic powder is an ε-iron oxide powder, and
a vertical squareness ratio of the magnetic recording medium measured after pressing the magnetic layer at a pressure of 70 atm is 0.50 to 0.95

2. The magnetic recording medium according to claim 1,
wherein the magnetic layer contains inorganic oxide-based particles.

3. The magnetic recording medium according to claim 2,
wherein the inorganic oxide-based particles are composite particles of an inorganic oxide and a polymer.

4. The magnetic recording medium according to claim 1,
wherein the vertical squareness ratio is 0.50 to 0.80.

5. The magnetic recording medium according to claim 1,
wherein the ε-iron oxide powder contains one or more kinds of elements selected from the group consisting of a gallium element, a cobalt element, and a titanium element.

6. The magnetic recording medium according to claim 1, further comprising:
a non-magnetic layer containing a non-magnetic powder between the non-magnetic support and the magnetic layer.

7. The magnetic recording medium according to claim 1, further comprising:
a back coating layer containing a non-magnetic powder on a surface side of the non-magnetic support opposite to a surface side on which the magnetic layer is provided.

8. The magnetic recording medium according to claim 1,
wherein the magnetic recording medium is a magnetic tape.

9. A magnetic tape cartridge comprising:
the magnetic tape according to claim 8.

10. The magnetic tape cartridge according to claim 9,
wherein the magnetic layer of the magnetic tape contains inorganic oxide-based particles.

11. The magnetic tape cartridge according to claim 10,
wherein the inorganic oxide-based particles are composite particles of an inorganic oxide and a polymer.

12. The magnetic tape cartridge according to claim 9,
wherein the vertical squareness ratio is 0.50 to 0.80.

13. The magnetic tape cartridge according to claim 9,
wherein the ε-iron oxide powder contains one or more kinds of elements selected from the group consisting of a gallium element, a cobalt element, and a titanium element.

14. A magnetic recording and reproducing device comprising:
the magnetic recording medium according to claim 1.

15. The magnetic recording and reproducing device according to claim 14,
wherein the magnetic layer of the magnetic recording medium contains inorganic oxide-based particles.

16. The magnetic recording and reproducing device according to claim 15,
wherein the inorganic oxide-based particles are composite particles of an inorganic oxide and a polymer.

17. The magnetic recording and reproducing device according to claim 14,
wherein the vertical squareness ratio is 0.50 to 0.80.

18. The magnetic recording and reproducing device according to claim 14,
wherein the ε-iron oxide powder contains one or more kinds of elements selected from the group consisting of a gallium element, a cobalt element, and a titanium element.

19. The magnetic recording and reproducing device according to claim 14,
wherein the magnetic recording medium is a magnetic tape.
